(19) United States
(12) Patent Application Publication
(10) Pub. No.: US 2003/0050060 A1
(43) Pub. Date: Mar. 13, 2003

(54) Communications architecture utilizing local satellite processors

(76) Inventors: William Leslie, Santa Clara, CA (US); Marcclo San Martin, Alviso, CA (US)

Correspondence Address: CARR & FERRELL LLP, 2225 EAST BAYSHORE ROAD, SUITE 200, PALO ALTO, CA, 94303, US

(21) Appl. No.: 10/232,262

(22) Filed: Aug. 29, 2002

Related U.S. Application Data
(60) Provisional application No. 60/316,748, filed on Aug. 31, 2001.

(51) Int. Cl. H04Q 7/20

(52) U.S. Cl. 455/427; 455/428

(57) ABSTRACT

A communications device wherein software modules performing functions related to communications are linked together using local satellite processors. When one module generates a request for a second module, the local satellite processor intercepts this signal and either send the signal on to the indicated active module, or reacts to the communication if it is directed towards an inactive module. The local satellite processors may also manage communications between modules by using a queue. The incoming signals are placed in a queue for transmission to the designated module based on some priority system. Furthermore, the queue may be used to allow modules to suspend work on a job while waiting for more information by holding all other signal traffic in the queue.

### CROSS-REFERENCE TO RELATED APPLICATIONS

The present application claims priority of Provisional Patent Application Serial No. 60/316,748, filed Aug. 31, 2001 and entitled “Communications Architecture Utilizing Local Satellite Processors,” which is incorporated herein by reference in its entirety.

### BACKGROUND OF THE INVENTION

1) Field of the Invention

The invention relates generally to telecommunications, and more particularly to modular software architecture.

2) Description of Background Art

FIG. 1 is a diagram of an existing communications network which includes a public switch telephone network (PSTN) 110, the Internet Protocol network (Internet) 120, a media gateway controller and media gateway (MGC/MGW) 130, several integrated access devices (IAD) 140, several conventional telephones 150, several computers 160, and several Session Initiation Protocol (SIP) telephones 170. PSTN 110 is a conventional switchboard station, designed to connect parties making telephone calls and transmit voice data. Internet 120, designed to transmit any form of electronic data packets, provides access to a variety of Internet services. PSTN 110 is accessed directly with conventional telephones 150 while Internet 120 is accessed indirectly with conventional telephones 150 through an intermediary IAD 140. However, SIP telephones 170 and computers 160 are specially designed to connect directly to the Internet 120.

MGC/MGW 130 merges the two networks 110 and 120 by providing a translation mechanism that allows the two networks 110 and 120 to permit the transfer of information. Traditional MGC/MGW 130 architecture uses circuit switches. Circuit switches have several problems, including being dependent on a single vendor who supplies the software, hardware, and applications in one proprietary package. Customization and change are, therefore, slow and expensive.

An alternative MGC/MGW 130 is a softswitch, an open-standard software solution to network integration. In order to provide optimal control of intrinsic features, the softswitch architecture has evolved with specialized protocols such as SIP, SS7 and CPL. Using these different protocols, however, is a cumbersome process.

Despite the availability of conventional softswitches, many functions such as account management, billing, call forwarding, etc. remain based on PSTN 110, limiting the flexibility of the network. What is needed is a system or method that overcomes some of the disadvantages in the prior art.

### BRIEF SUMMARY OF THE INVENTION

One embodiment of the invention is a communications device that has at least one software module that performs communications related functions. In the process of performing its functions, the software module generates requests to other software modules that perform other communications functions. The module generates the requests to the other modules regardless of whether the other modules are actually available. A local satellite processor is used to intercept requests from the request generating module. When the other module indicated in the request is available, the local satellite processor directs the request to that satellite module. When the indicated module is not available and a response is expected, the local satellite processor generates a mock reply back to the requesting module.

The types of communications-related functions capable of being performed by the software modules are connection management, signaling, quality of service, access control, call control, call features, call management, call routing, SIP address translations, user authentication, directory services, fault functions, configuration functions, accounting functions, performance monitoring, security and like communications functions. The local satellite processors are configured to receive multiple requests and process them in a queue.

Another embodiment of the invention is a method of managing communication from a first software module to a second software module using a local satellite processor. The local satellite processor is first configured to operate in either transparent mode if the second software module is active or mock reply mode if the second software module is inactive. Communications between modules are then intercepted by the local satellite processor. In the transparent mode, the communication from the first software module is sent along to the second software module without interference or processing. However, if the local satellite processor is in second software module is inactive, the local satellite processor operates in mock reply mode. The local satellite processor is configured to examine the communication and react to the communication based on the examination. In one embodiment, the reaction to the communication is to disregard the communication. In another embodiment, however, the local satellite processor response to the communication by returning a mock reply back to the first software module.

In another embodiment, the method of managing communications from a first software module to a second software module using local satellite processors includes the step of queuing commands if multiple commands are received. The position of an input in the queue may be determined based on the time the input was received, the position may be determined based upon a priority system based on the nature of the signal request or other like criteria.

In yet another embodiment queuing can be used to allow modules to suspend work on a job while waiting for more information by holding all other signal traffic to that software module for the job in the queue.

In a final embodiment local satellite processors can assist in communication management by facilitating the creation of multiple products from the same software modules.

### BRIEF DESCRIPTION OF THE DRAWINGS

FIG. 1 is a prior art diagram of an existing communications network;

FIG. 2 is a block diagram showing a multi-engine application platform interacting with external systems;

FIG. 3 is a block diagram showing the architecture of the multi-engine application platform;

FIG. 4 is a block diagram showing the architecture of a connection logic control module;

FIG. 5 is a block diagram showing the architecture of a service logic control module;

FIG. 6 is a block diagram showing the architecture of a subscriber and policy server module;

FIG. 7 is a block diagram showing the architecture of a fault, configuration, accounting, performance and security subsystem module; and

FIG. 8 is a block diagram showing the derivative devices made from the various modules.

### DETAILED DESCRIPTION OF THE INVENTION

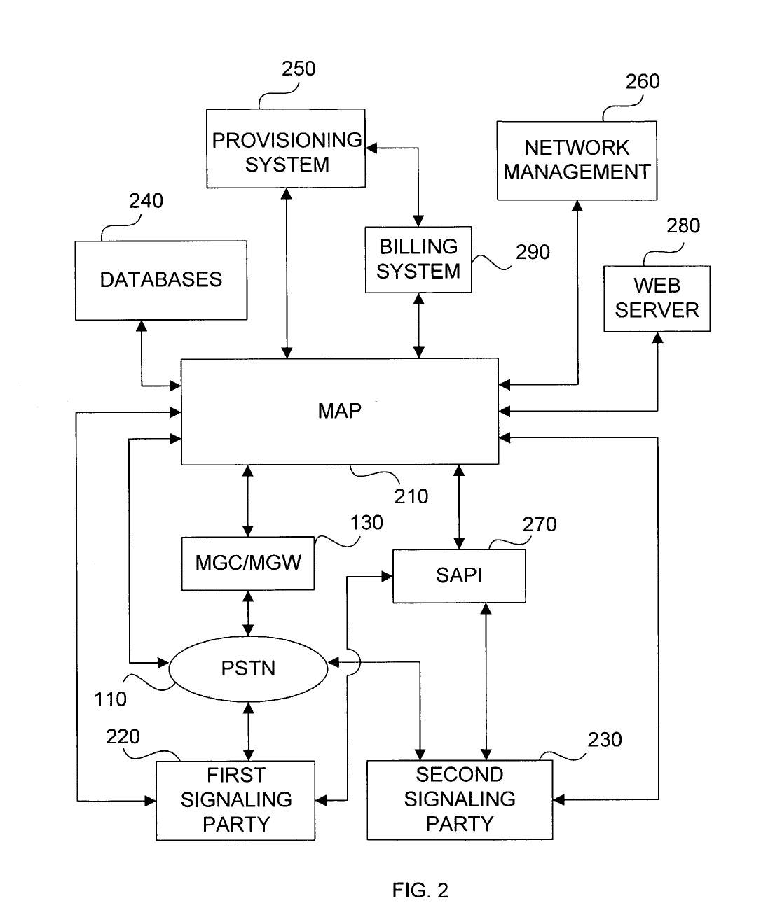

FIG. 2 is a block diagram that shows interactions between a multi-engine application platform (MAP) 210 and a variety of other systems. MAP 210 provides an infrastructure for telephony service providers that is a highly reliable, massively scalable IP-centric architecture that combines aspects of traditional telephony, IP transport and emerging Internet multimedia applications. Enhanced services that are not available through a PSTN 110 based architecture can include unified messaging, web-based interactive voice response (IVR), multimedia voice/data/fax/video support, fixed rate pricing, leveraging of wireless and wireline services, sophisticated fraud and policy control mechanisms, and efficient management of the underlying information and services.

The interactions shown in FIG. 2 can include communications between MAP 210 and a first signaling party 220, a second signaling party 230, databases 240, a provisioning system 250, a network management system 260, a subscriber application program interface (SAPI) 270, a web server 280, a billing system 290, MGC/MGW 130, and PSTN 110.

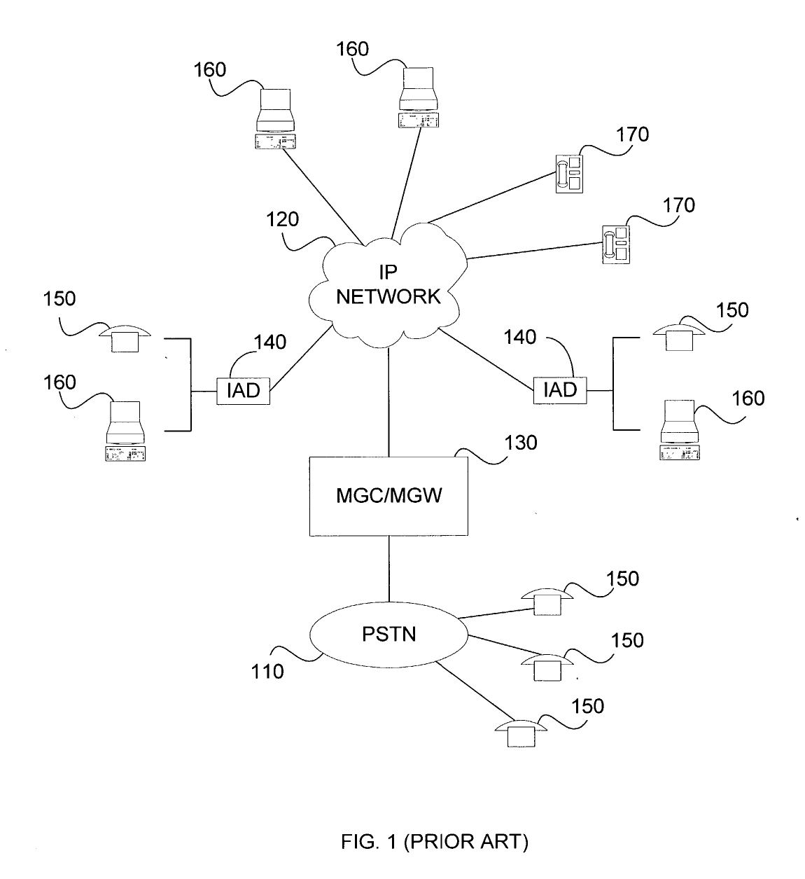

Although both of the first signaling party 220 and second signaling party 230 are shown with connections to PSTN 110, SAPI 270, and MAP 210, a signaling party can have fewer than these connections. For example, a direct connection to MAP 210 can be made if the signaling party includes IAD 140, computer 160 or SIP telephone 170 of FIG. 1. Thus, a signaling party using a conventional telephone 150 will indirectly access MAP 210 through PSTN 110 and MGC/MGW 130. Additionally, in some embodiments only the customers of a MAP 210 provider will have access to SAPI 270 to provide a client interface and access to features such as call forwarding. TAPI 3.0 provided by Microsoft, Inc. is an example of a commercially available product that can be used to create a custom SAPI 270. Similarly, in some embodiments only the customers of the MAP 210 provider have access to web server 280 to allow, for example, account review and modifications to be made over the Internet. An example of a free web server 280 that can be used with MAP 210 is Apache by The Apache Group.

Provisioning system 250 is an intermediary system that can be used by MAP 210 to provide customer services, log transactions, carry out requests, update files and like functions. An example of a commercially available provisioning system 250 is M/5 provided by MetaSolv, Inc. In some embodiments provisioning system 250 can interact with billing system 290 to facilitate accounting. An example of a commercially available billing system 290 is Arbor®/BP by Lucent, Inc.

Network management system 260 provides protocols necessary to communicate with external devices (not shown) and databases 240. HP OpenView by Hewlett-Packard, Inc. is an example of a commercially available network management system 260, and Netscape Directory Server by Netscape Corporation is an example of a database 240.

MAP 210 can be developed much more quickly then if the combination of commercially available components were each independently developed. In one embodiment, databases 240, provisioning system 250, network management system 260, SAPI 270, web server 280, billing program 290, and MGC/MGW 130 are realized by using existing known products. The development time of MAP 210 is further reduced by using a layered architecture. Various modules are used that are separated according to functionality. Since each module accomplishes a discrete function, multiple modules are required to process a single call.

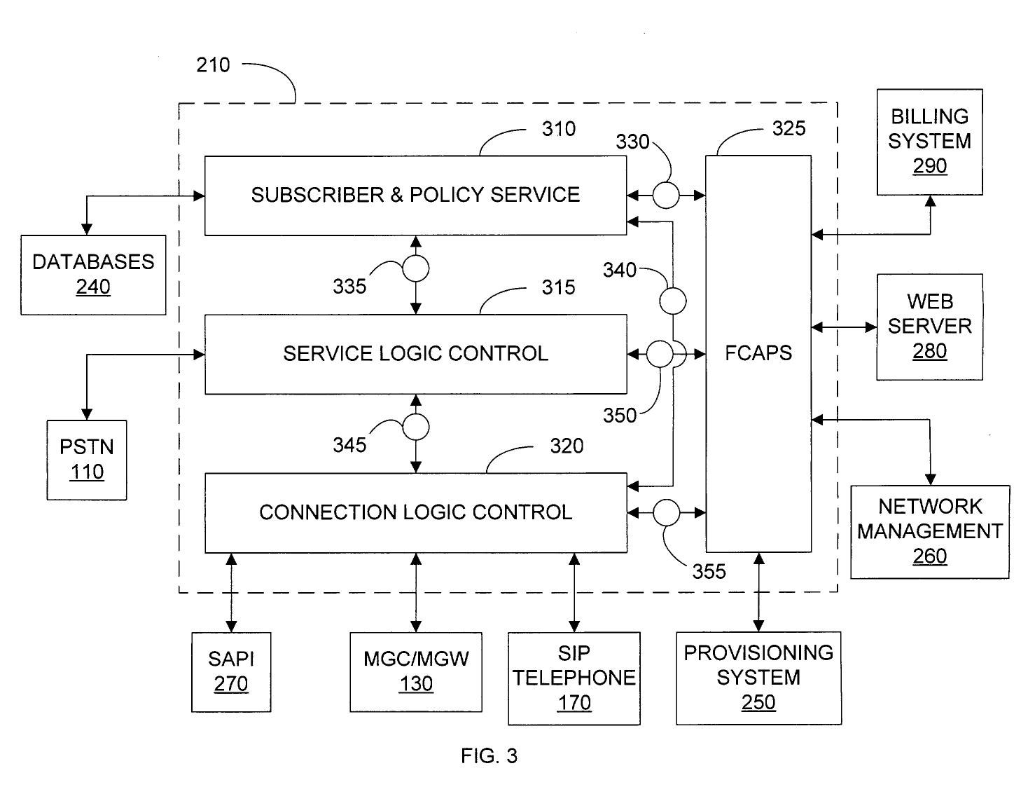

FIG. 3 is a block diagram of an exemplary MAP 210 architecture in accordance with a specific embodiment. MAP 210 includes a subscriber and policy service module 310, a service logic control module 315, a connection logic control module 320, a fault, configuration, accounting, performance and security module (FCAPS) 325, and local satellite processors 330, 335, 340, 345, 350, and 355. The local satellite processors can be implemented in hardware, software and/or a combination thereof. MAP 210 architecture is preferably designed to have distributed control intelligence in order to meet the reliability of PSTN 110 based systems. Distributed control makes the system less communication intensive and less vulnerable to failure.

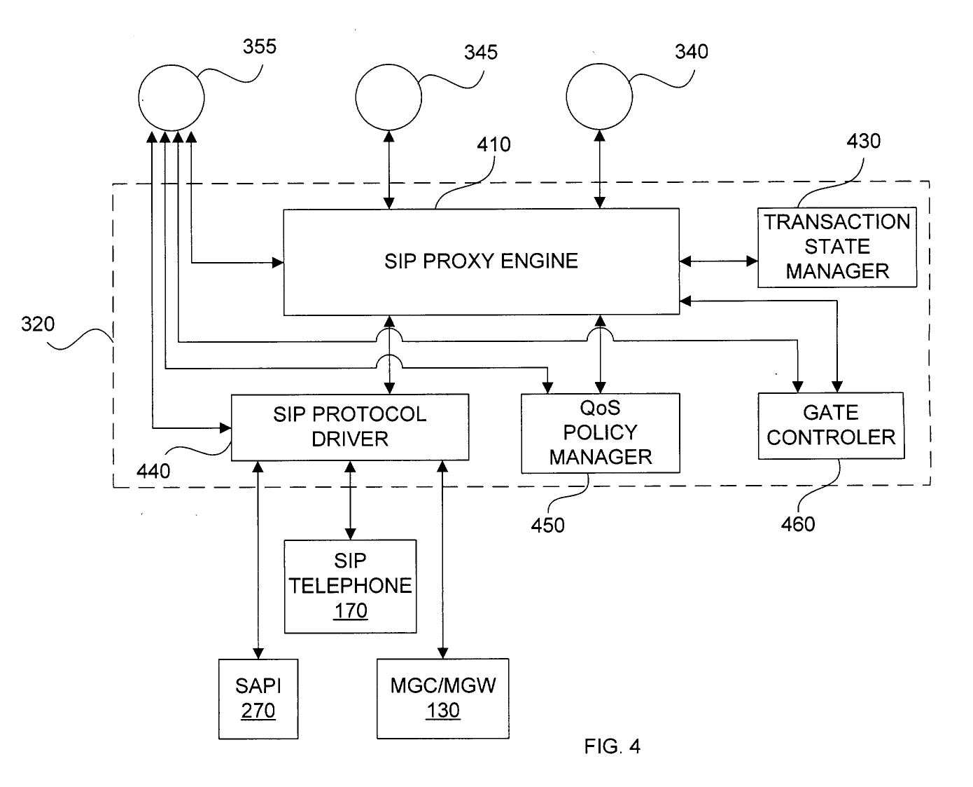

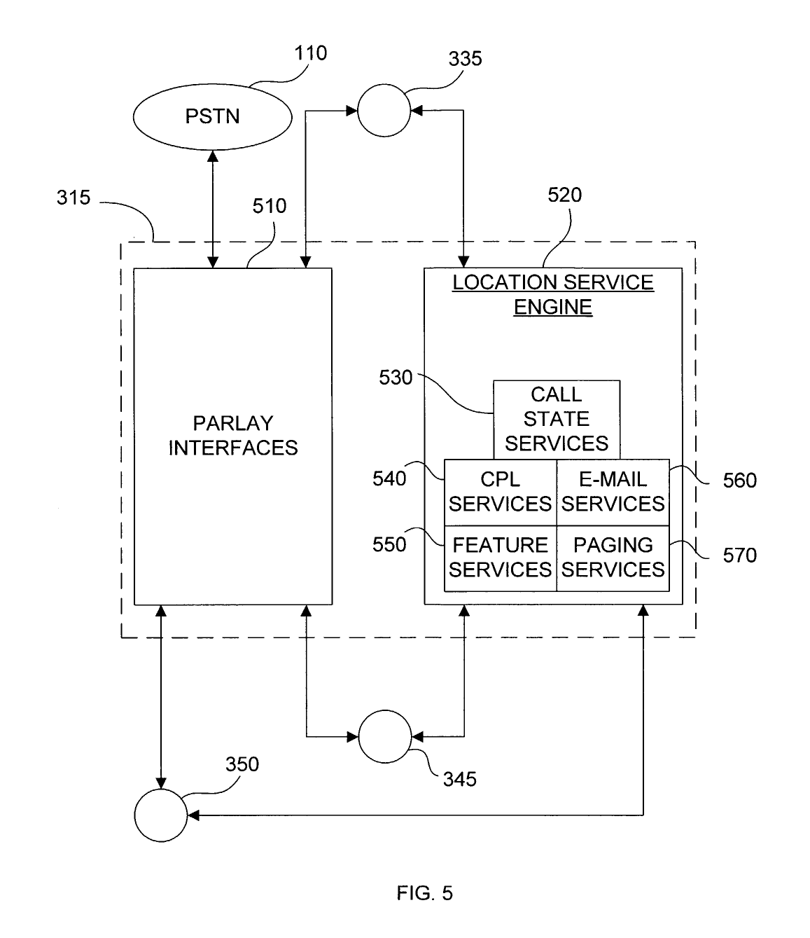

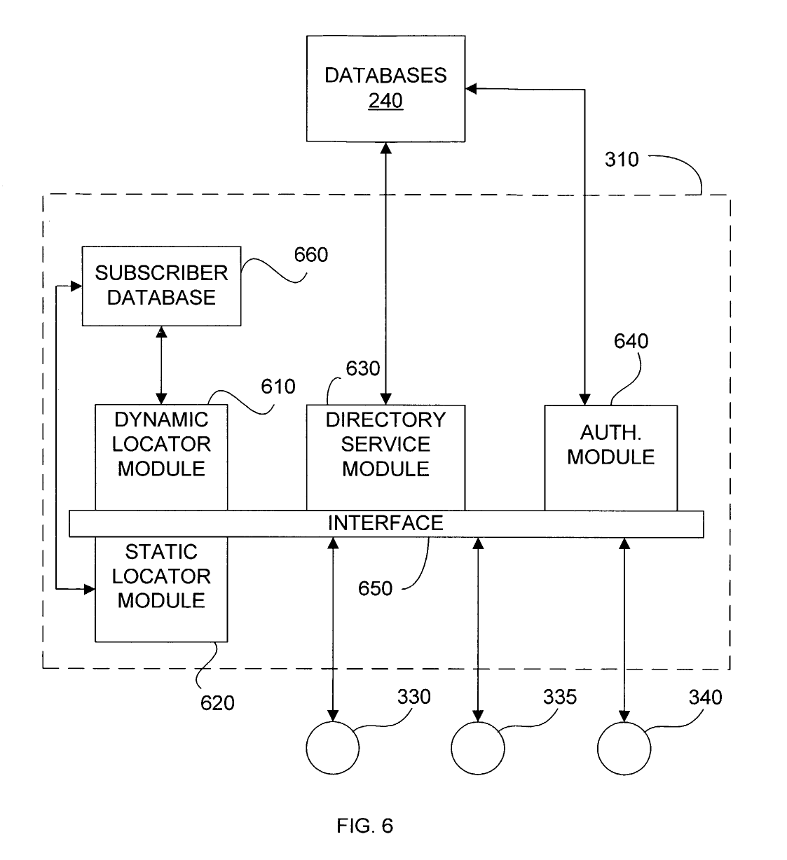

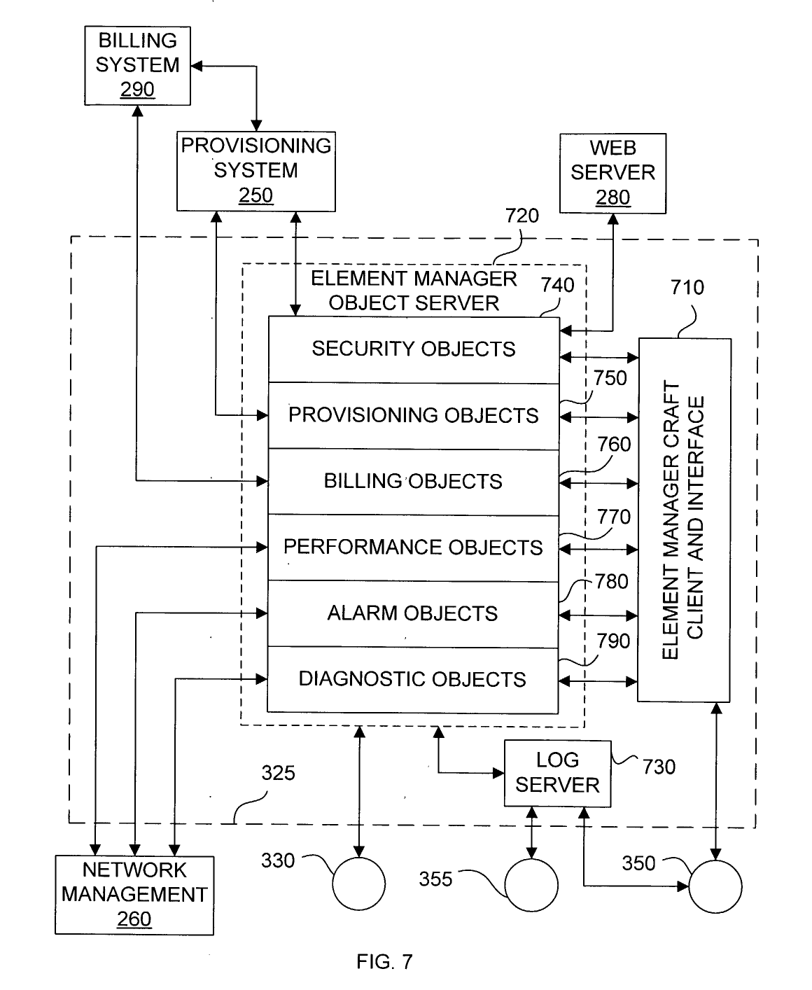

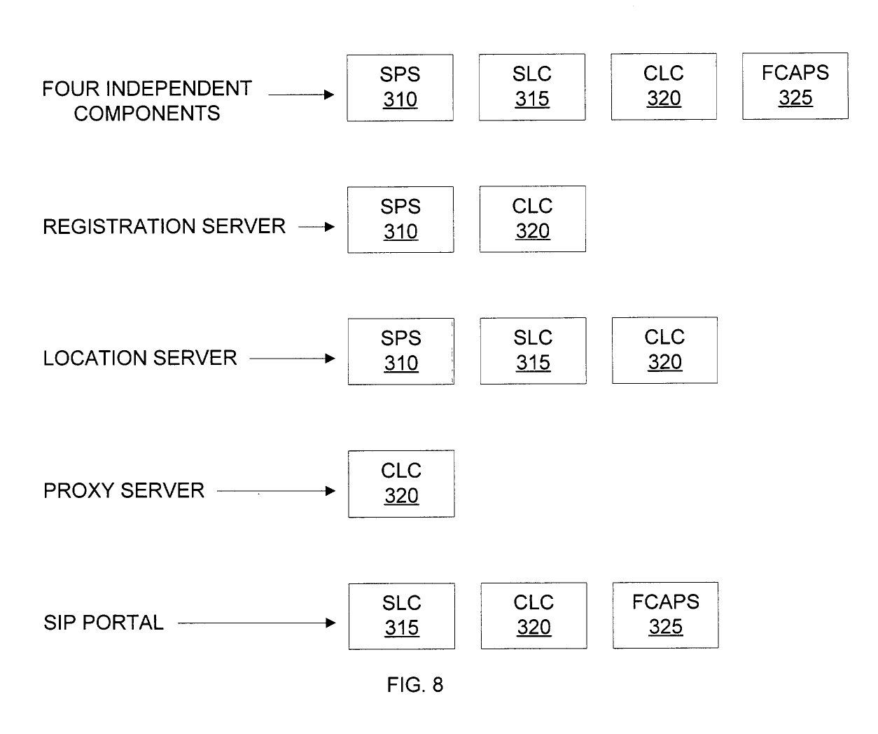

Connection logic control module (“CLC”) 320 provides support for network services such as connection management, signaling, quality of service policy (QoS), access control and MGC/MGWs, as is further discussed in conjunction with FIG. 4 below. Service logic control module 315 provides support for call control, call features (such as *69), and inbound and outbound call management via Call Processing Language (CPL) for e-mail, paging and like services, as is further discussed in conjunction with FIG. 5 below. Subscriber and policy service module 310 performs call routing, SIP address translation, user name and password authentication, and directory services, as is further discussed in conjunction with FIG. 6 below. FCAPS 325 provides all operational support system interfaces, as is further discussed in conjunction with FIG. 7 below. Local satellite processors 330, 335, 340, 345, 350, and 355 allow derivative devices to be used and further reduce development time, as is discussed in connection with FIG. 8 below.

Referring again to FIG. 2, in some embodiments MAP 210 facilitates a connection between first signaling party 220 and second signaling party 230. First signaling party 220 can be connect though SAPI 270, MGC/MGW 130, or SIP telephone 170. Returning to FIG. 3, when first signaling party 220 requests a connection to second signaling party 230, MAP 210 receives an IP signal through connection logic control module 320. Connection logic control module 320 then sends a request to FCAPS 325 for authorization to proceed and initiate billing procedures. In response to the authorization request, FCAPS 325 initiates a request to subscriber and policy service module 310 to both identify and locate the first signaling party and the second signaling party. Once subscriber and policy service module 310 accesses the appropriate databases 240 and returns the information to FCAPS 325, FCAPS returns an authorization to connection logic control module 320. Connection logic control module 320 then relays the information to service logic control module 315, which either directly performs the tasks necessary to appropriately signal and connect both parties 220 and 230, or makes a request to an external system to accomplish the necessary tasks.

FIG. 4 is a block diagram showing the architecture of the connection logic control module 320 for providing support for network services. Connection logic control module 320 includes a SIP proxy engine 410, a transaction state manager 430, a SIP protocol driver 440, a QoS policy manager 450 and a gate controller 460.

SIP protocol driver 440 provides connection control for SIP devices (such as SAPI 270, SIP telephone 170 and MGC/MGW 130) and other SIP servers, preferably accepting and establishing connections in either Transmission Control Protocol (TCP), User Datagram Protocol (UDP) or other equivalent protocols. When SIP protocol driver 440 receives a SIP message, it converts the SIP message from text format to a SIP object.

After receiving the SIP object from SIP protocol driver 440, SIP proxy engine 410 carries out the command by executing the appropriate call logic. For example, when an “invite” message from a caller is received, the SIP proxy engine 410 sends a request for authorization to the subscriber and policy service module 310, passes on the “invite” message from the caller to the service logic control module 315 if the caller is authorized, initiates a new “invite” message to the intended call recipient, informs the caller when the recipient's phone is ringing, terminates the call when appropriate, and stores the transaction records in transaction state manager 430. Transaction state manager 430 includes a database of transaction records and a database management system.

In some embodiments QoS policy manager 450 is configured to implement the QoS policy decision point (PDP) requirements of the Internet Engineering Task Force (IETF). The IETF has defined through the PDP requirements how certain levels of QoS should be processed depending upon the specifics of either a connection or by the session description part (SDP) of a SIP message.

Gate controller 460 provides security through firewalls and proxy functions, determining whether to allow or deny a connection. A firewall is typically used to separate a secured network from an unsecured network such as the public Internet. If a call recipient resides on the secured side of a firewall, certain security protocols may be required. When possible, gate controller 460 provides the necessary security protocols to the call recipient.

As shown in FIG. 3, connection logic control module 320 is coupled to FCAPS 325 by local satellite processor 355 that acts as an intermediary therebetween, as will be discussed further in connection with FIG. 8. From within connection logic control module 320 the SIP proxy engine 410, SIP protocol driver 440, QoS policy manager 450, and gate controller 460 each obtain required configuration parameters from FCAPS 325 in order to function. Additionally, components 410, 440, 450, and 460 send performance, alarm, and log records to FCAPS 325. In a similar fashion, when SIP proxy engine 410 requires participation from subscriber and policy service module 310 or service logic control module 315, communication takes place through intermediary local satellite processors 345 and 340.

Returning to FIG. 3, the connection logic control module 320 interacts with PSTN 110 through MGC/MGW 130 to receive and interpret electronic signals representing one or more states of communication, such as “off hook,” “digits of keyboard,” “on hook,” or the like. Alternatively, the first signaling party 220 can avoid the PSTN all together and connect directly to connection logic control module 320 by using an IAD 140 or SIP telephone 170. Although a call from first signaling party 220 will typically come through connection logic control module 320, as described, some embodiments of the invention also allow service logic control module 315 to connect to PSTN 110, for example, through an extended signaling system 7 (SS7) network implementing SIP for telephones (SIP-T). In order to connect to PSTN 110 service logic control module 315 acts as a service control point (SCP), the element that provides call routing and enhanced services within PSTN 110.

It should be noted that although the various components have been functionally separated, it will be apparent to one skilled in the art that the various components can be further subdivided or combined into fewer, or even a single, component. Such simple alterations are considered to be within the scope of the described invention.

FIG. 5 is a block diagram showing service logic control (“SLC”) module 315 architecture which includes Parlay interfaces 510 and a location service engine 520. The Parlay interfaces 510 map the Parlay API Specification (an open standard application programming interface for service capabilities such as call control, messaging, and security) onto the SIP transaction model. Location service engine 520 can include a call state services subsystem 530, a CPL services subsystem 540, a feature services subsystem 550, an e-mail services subsystem 560, and a paging services subsystem 570, as will be discussed below.

Location service engine 520 first attempts to locate an address of a destination party after receiving an “invite” message from connection logic control module 320 and then maintains the session states. Location service engine 520 can locate the address through a variety of services, including but not limited to, DNS location, routing tables (such as tables for E.164 numbered addresses), current mobility data from databases 240, feature based mapping (such as *69), and CPL interpretation.

Location service engine 520 can be designed in many different ways. For example, the engine 520 can be made up of many state machines, java scripts, or CGI scripts where each state machine, java script or CGI script handles one individual transaction (SIP message). An individual transaction is executed according to the rules established in a CPL services subsystem 540. The state information which must be maintained for the duration of each session is held in the call state services subsystem 530.

In some embodiments location service engine 520 includes the feature services subsystem 550 to provide support for call feature codes that are not recognizable as caller addresses, such as *69. Location service engine 520 can also include the e-mail services subsystem 560 to provide support for e-mail notifications, and the paging services subsystem 570 to provide support for paging notifications. Location service engine 520 can therefore accommodate detailed schedules and services to provide, for example, a beeper number for weekends, a cell phone number for lunch time, and a branch office number for every other Tuesday, and a report of each incoming call sent to a particular email address. Additional subsystems can be added to allow, for example, the location service engine 520 to act as a SIP portal to other external services that are accessed with SIP.

FIG. 6 is a block diagram of subscriber and policy service (“SPS”) module 310 including a dynamic locator module 610, a static locator module 620, a directory service module 630, an authentication module 640, an interface module 650, and a subscriber database 660. Subscriber information stored in subscriber database 660 is updated by both dynamic locator module 610 and static locator module 620, depending on how frequently the information is subject to be changed. For example, information such the location of a party at a particular time, which is likely to change several times per day, is updated by dynamic locator module 610. On the other hand, infrequently altered information, such as a local number portability (LNP) or a client mailing address, is updated by static locator module 620. Although dynamic locator module 610 and static locator module 620 are combined into a single module in some embodiments, the design considerations are different enough that separate modules are preferred.

Directory service module 630 is coupled to databases 240 and allows updates, searches, and lookups, as well as basic directory operations, and in preferred embodiments is configured to do so independently of the method of storage employed by the databases 240. If directory service module 630 is configured to use, for example, a Lightweight Directory Access Protocol (LDAP) for accessing directories, the directory service module 630 would be limited in its ability to use databases and cache in order to support high frequency updates.

Authentication module 640 is also coupled to databases 240 and is configured to accept authentication requests and to verify the identity of at least one of the signaling party 220 or 230. Authentication can be accomplished with a wide variety of protocols ranging from the simplest username/ password combinations to more advanced protocols such as the Secure Sockets Layer Protocol (SSL), the Transport Layer Security Protocol (TLS), or like protocols.

Interface module 650 is a shared interface. Interface module 650 couples modules 610, 620, 630, and 640 to local satellite processors 330, 335, and 340, as shown.

FIG. 7 is a block diagram of FCAPS module 325. FCAPS module 325 includes an element manager craft client and interface 710, an element manager object server 720, and a log server 730.

Log server 730 receives information from connection logic control module 320 via local satellite processor 355. High priority information (alarms and call trace information) is immediately sent to element manager object server 720 and element manager craft client and interface 710. Log server 730 employs alarm stacks to keep track of all active alarms and additionally employs diagnostic stacks to keep track of call trace information. By contrast, medium priority information (performance and customer initiated diagnostic information) is not immediately sent to element manager object server 720, but is instead directed to either a performance stack or the diagnostic stack to await processing. Low priority information (system initiated diagnostic information and general logging information) is stored in a short term system log database of the log server 730 that maintains a log of all information (high, medium and low priority) and awaits processing when system activity is low.

Element manager craft interface 710 is an optional alternative to the provisioning system 250. Element manager craft client and interface 710 allows operations personnel, for example, to configure, diagnose, manually provision, and monitor the system. Since all system maintenance operations can be initiated from element manager craft interface 710, element manager craft interface 710 is able to interface with all of the objects hosted by element manager object server 720. The objects hosted by element manager object server 720 will be discussed more fully, below.

Element manager object server 720 allows secure access to log server 730, secure access to databases 240 through local satellite processor 330, and provides a common server for the various objects that perform many of the functions of FCAPS 325. Element manager object server 720 also gathers information about alarm and performance data and formats the information to be transmitted to network management system 260. The type of formatting that is required depends on the particular network management system 260 that is used. For example, if network management system 260 uses the Transaction Language One Protocol (TL1), all network management information is transmitted to network management system 260 via a TL1 ASCII (text) message. In those embodiments in which network management system 260 uses the Simple Network Management Protocol (SNMP), most network management information is stored in management information bases (MIB), with the exception of asynchronous alarms, which are sent to SNMP trap addresses.

The objects hosted by element manager object server 720 include security objects 740, provisioning objects 750, billing objects 760, performance objects 770, alarm objects 780, and diagnostics objects 790. Security objects 740 implement security policies that regulate the access of the element manager craft client and interface 710, web server 280, and provisioning system 250 to information in databases 240. Provisioning objects 750 allow data elements such as name, address, and subscribed services to be properly exposed to provisioning system 250 from the element manager craft client and interface 710. Likewise, billing objects 760 allow accounting data elements to be properly exposed to billing system 290. Similarly, performance objects 770 and alarm objects 780 expose various performance and alarm messages from log server 730 to network management system 260 and to element manager craft client and interface 710. Additionally, diagnostic objects 790 expose call trace and diagnostic information from log server 730 to the element manager craft client and interface 710.

FIG. 8 is a block diagram illustrating some derivative devices that can be realized using components of the MAP 210. As described above, the four major independent components of the MAP architecture 210 are the subscriber and policy service module 310, service logic control module 315, connection logic control module 320, and FCAPS module 325. However, in some embodiments it is desirable to utilize less than the full MAP 210 functionality, and in these embodiments the modules 310, 315, 320 and 325 are used in various combinations to create various derivative devices such as the ones discussed below.

For example, a registration server (used to register a subscriber and get a service) can be constructed by combining subscriber and policy service module 310 with a connection logic control module 320. Local satellite processors 330, 335, 345, and 355 allow subscriber and policy service module 310 and connection logic control module 320 to function without the other two modules 315 and 325.

During normal operation of MAP 210, local satellite processors 330, 335, 340, 345, 350, and 355 act as transparent conduits between modules 310, 315, 320 and 325. However, when service logic control module 315 and FCAPS module 325 are absent (or are not being used), the local satellite processors 330, 335, 345 and 355 intercept requests to these modules and either disregard them or send back dummy responses that do not effect the functionalities of the active modules 310 and 320. Therefore, MAP 210 can be converted into a registration server through merely the modification of local satellite processors 330, 335, 345 and 355, and without having to make changes to the active modules 310 and 320. It should be noted that in the registration server configuration the local satellite processor 340 between the active modules 310 and 320 is unchanged (transparent) and the local satellite processor 350 between the absent modules 315 and 325 is unused.

In a similar fashion, a location server (used to locate the destination party) is constructed by combining subscriber and policy service module 310, service logic control module 315 and connection logic control module 320. Only local satellite processors 330, 350 and 355 between the active modules 310, 315 and 320 and FCAPS module 325 are modified in the location server configuration.

By itself, connection logic control module 320 constitutes (i.e., emulates proxy secure functionality) a proxy server that sits between a client application and a real server (i.e., a dedicated physical or logical server). The proxy server intercepts all requests to the real server and fulfills any requests that it can. Requests that cannot be fulfilled by the connection logic control module 320 are forwarded to the real server. Modification of local satellite processors 340, 345 and 355 allow connection logic control module 320 to function in the absence of the other three modules 310, 315 and 325.

The addition of service logic control module 315 and FCAPS module 325 converts the proxy server into a SIP portal, allowing a signaling party to use any SIP enabled service and to be appropriately billed. The local satellite processors 330, 335 and 340 that connect the subscriber and policy service module 310 to the other systems are modified in the SIP portal configuration.

It will be apparent from the above examples that an additional benefit of local satellite processors 330, 335, 340, 345, 350 and 355 is that they allow for a decreased development time for MAP 210. The development time is decreased because the local satellite processors 330, 335, 340, 345, 350, and 355 separate modules 310, 315, 320, and 325 from one another which then allows the modules 310, 315, 320 and 325 to be developed and deployed independently.

In some embodiments, each of the local satellite processors 330, 335, 340, 345, 350, and 355 employ queues to send inputs to the various modules 310, 315, 320, and 325. Queuing allows different jobs to be lined up while waiting to be executed. Execution can proceed, for example, according to either the order in which the jobs were received by the queue, according to a priority system, or in a reverse order from which the jobs were received. Additionally, queuing allows modules 310, 315, 320 and 325 to suspend work on a single job while waiting for more information from other sources or other modules 310, 315, 320, and 325.

In one embodiment, local satellite processors 330, 335, 340, 345, 350, and 355 each include instructions that dictate the response that may be generated according to the modules 310, 315, 320 and 325 that are active given a variety of configurations for creating derivative devices. For instance, local satellite processor 330 can have a specific set of instructions for generating a response to a request when modules 310 and 325 are active, and another set of instructions for responding to a request when modules 310 and 320 are active.

In some embodiments of the present invention, FCAPS 325 operates to coordinate the combined functionality of one or more modules 310, 315. 320, and 325. More specifically, FCAPS 325 communicates with and configures each local satellite processor 330, 335, 340, 345, 350, and 355 to either operate in transparent mode (i.e., allow signals and data to be exchanged between active modules) or in mock-reply mode. In such embodiments, FCAPS 325 configures each local satellite processor 330, 335, 340, 345, 350, and 355 depending upon which modules 310, 315, 320, and 325 are active at a particular point in time. Additionally, FCAPS 325 can configure the satellite processor to form a particular configuration relating to at least one of the derivative devices.

the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive.

We claim:

1. A communications device comprising:
at least one first module that performs a function relating to communications and is configured to generate a request to at least one second module that performs a function relating to communications, regardless of whether the at least one second module is available; and
at least one local satellite processor that receives the request to the at least one second module from the at least one first module and,
when the at least one second module is present, directs the request to the at least one second module, and
when the at least one second module is not present, and when a request is expected from the at least one second communication module, provides a mock reply back to the at least one first module.

2. The communications device of claim 1, wherein the function relating to communications are selected from the group comprising: connection management; signaling; quality of service; access control; call control; call features; call management; call routing; SIP address translations; user authentication; directory services; fault functions; configuration functions; accounting functions; performance monitoring; and security.

3. The communications device of claim 2, wherein the at least one local satellite processor can receive multiple requests and processes them in a queue.

4. A method of managing communication from a first software module to a second software module using a local satellite processor, comprising:
configuring the local satellite processor to be in a transparent mode if the second software module is active;
configuring the local satellite processor to be in a mock reply mode if the second software module is inactive;
intercepting the communication with the local satellite processor;
sending the communication to the second software module if the local satellite processor is in transparent mode;
examining the communication if the local satellite processor is in mock reply mode; and
reacting to the communication based on the examination if the local satellite processor is in mock reply mode.

5. The method of managing communication of claim 4, wherein reacting to the communication is disregarding the communication.

6. The method of managing communication of claim 4, wherein reacting to the communication is sending a mock reply back to the first software module.

7. The method of managing communication of claim 4, further comprising the step of queuing commands if multiple commands are received.

8. The method of managing communication of claim 7, wherein the position of an input in the queue is based on the time the input was received.

9. The method of managing communication of claim 7, wherein the position of an input in the queue is based upon a priority system based on the nature of the signal request.

10. The method of managing communication of claim 7, wherein queuing can be used to allow modules to suspend work on a job while waiting for more information by holding all other signal traffic to that software module for the job in the queue.

11. The method of managing communication of claim 4, wherein the local satellite processors are used to create at least one derivative product utilizing at least one of the at least one first software module and the at least one second software module.

12. A method of managing communications, comprising:
receiving at least one request from a first module;
determining whether a second module is available to respond to the at least one request;
forwarding the at least one request to the second module upon a determination that the second module is available to respond; and
generating a response associated with the at least one request upon a determination that the second module is not available to respond.

13. The method of claim 12, wherein the request relates to at least one of: connection management, signaling, quality of service, access control, call control, call features, call management, call routing, SIP address translations, user authentication, directory services, fault functions, configuration functions, accounting functions, performance monitoring, and security.

14. The method of claim 12, wherein the response generated is a mock reply.

15. The method of claim 12, further comprising storing the at least one request in a queue.

16. The method of claim 15, further comprising assigning a position to the at least one request in the queue.

17. The method of claim 16, wherein the at least one request is extracted from the queue according to the position.

18. The method of claim 15, further comprising assigning a priority to the at least one request in the queue.

19. The method of claim 18, wherein the at least one request is extracted from the queue according to the priority.

20. The method of claim 15, further comprising assigning a time to the at least one request in the queue.

21. The method of claim 20, wherein the at least one request is extracted from the queue according to the time.

22. A system for managing communications utilizing local satellite processors, comprising:
a first module configured to generate at least one request;
at least one second module configured to respond to the at least one request; and
at least one local satellite processor configured to perform at least one of delivery of the at least one request to the at least one second module when the at least one second module is available and generation of a response to the at least one request when the at least one second module is not available.

23. The system of claim 22, wherein the first module is at least one of a subscriber and policy service module, a service logic control module, a connection logic control module, and a fault, configuration, accounting, performance and security module.

24. The system of claim 22, wherein the second module is at least one of a subscriber and policy service module, a service logic control module, a connection logic control module, and a fault, configuration, accounting, performance and security module.

25. The system of claim 22, wherein at least one of the first module and the second module dictates the response generated by the at least one local satellite processor.

26. The system of claim 22, wherein each of the at least one local satellite processor includes instructions particular to the local satellite processor for generation of the response.

27. An electronically-readable medium having embodied thereon a program, the program being executable by a machine to perform method steps for providing closed captioning in a videoconference environment, the method steps comprising:
receiving at least one request from a first module;
determining whether a second module is available to respond to the at least one request;
forwarding the at least one request to the second module upon a determination that the second module is available to respond; and
generating a response to the at least one request upon a determination that the second module is not available to respond.
